(19) United States
(12) Patent Application Publication
(10) Pub. No.: US 2025/0235924 A1
(43) Pub. Date: Jul. 24, 2025

(54) FILTER ELEMENT FOR FLOW STABILISATION AND/OR PURIFYING A MELT OBTAINED DURING CASTING, AND A METHOD FOR PRODUCING A FILTER ELEMENT

(71) Applicant: Technische Universität Bergakademie Freiberg, Dresden (DE)

(72) Inventors: Benedict BAUMANN, Freiberg (DE); Christoph SALEWSKI, Freiberg (DE); Gotthard WOLF, Mettmann (DE); Andreas KESSLER, Wilsdruff (DE)

(21) Appl. No.: 18/838,636

(22) PCT Filed: Feb. 14, 2023
(86) PCT No.: PCT/EP2023/053580

§ 371 Date: Aug. 15, 2024

(30) Foreign Application Priority Data
Feb. 16, 2022 (DE) 10 2022 201 617.3

(51) Int. Cl. B22C 9/08; B33Y 10/00; B33Y 40/20; B33Y 70/10; B33Y 80/00

(52) U.S. Cl. CPC B22C 9/086; B33Y 10/00; B33Y 40/20; B33Y 70/10; B33Y 80/00

(57) ABSTRACT

In a filter element in which, for flow stabilization and/or purifying a melt used during casting, the melt is guided through the filter element, the filter element is designed as three-dimensional rib structures with openings as flow channels through which liquid melt is guided. The ribs of the rib structure are formed by particles made of a material that can be used as a mold material in casting technology, and by a binder by means of which the particles can be integrally bonded. The ribs are also provided on their surface with a coating of a polymer resin.

The invention relates to a filter element for flow stabilization and/or purifying a melt obtained during casting, and a method for producing a filter element.

In the field of molten metal filtration various approaches exist for increasing the filtration efficiency of the filters used for this purpose. In most cases the filter material is modified or substituted by other substances. Thus, for example, DE 10 2011 109 681 A1 describes increasing the filtration efficiency of “common molten metal filter geometries” with an active surface coating. The term “common molten metal filter geometry” refers to open-cell foam ceramic geometries, honeycomb geometries, spaghetti-filter geometries, perforated filter geometries and woven fiber filters, none of which have a defined filter and flow structure in order to laminarize the melt in the best possible way. DE 10 2011 109 682 A1 and DE 10 2020 000 969 A1 describe the use of carbon-bonded materials for iron and aluminum melt filtration. The filters are defined as “foamed structures”. DE 10 2011 109 684 A1, relating to the removal of gases from melts using filters, DE 2016 106 708 A1, relating to the use of filters for continuous molten metal filtration, and DE 10 2018 201 577 A1, relating to the removal of inclusions of different chemical compositions using ceramic molten metal hybrid filters, also describe filters with a foamed or not clearly defined filter structure.

WO 2017/008092 A1 describes a method for producing metal filters made of molybdenum or tungsten. A molybdenum or tungsten powder with different grain sizes is sintered, wherein the sintered bridges provide the strength of the filter and the non-sintered regions represent the pores for the molten metal filtration. There are no clearly defined filter or flow structures in this type of filter production. In the technical solution described in EP 3 325 428 B1, a filter element is described which is constructed from three-dimensional geometric cages and is intended to perform the task of metal purification. The filter element is produced either by thermoplast printing and then coating the printed framework with ceramic slip and firing it or by printing a ceramic slip. Although these filter elements can have defined filter structures, these only fulfill the task of melt purification and not laminarization. Furthermore, the filter elements consist of a sintered ceramic that does not decompose thermally after use and therefore cannot be recycled or can only be recycled to a very limited degree.

The present invention is based on the problem that defined filter and flow structures can be produced which enable a conversion of a turbulent flow into a largely laminar flow of liquid melt by flow stabilization and/or an effective retention of impurities, which may be contained in the molten metal, as well as a simple and environment-friendly disposal of used filter elements.

According to the invention, this problem is solved by a filter element having the features of claim 1. Claim 6 relates to a method of production. Advantageous embodiments and developments of the invention can be achieved by the features specified in the dependent claims.

A filter element according to the invention is formed with a three-dimensional rib structure with openings as flow channels through which the liquid melt is guided. Liquid melt can flow through the openings formed with the rib structure between ribs, and the ribs can be produced such that the flow is laminarized by flow stabilization and impurities, e.g. oxides, can be retained by the filter element.

The rib structure is formed with particles made of a material that can be used as mold material in casting technology and with a binder. The particles are bonded integrally together with the binder and the surface of the ribs is coated with a polymer resin.

Preferably, particles can be used which are formed predominantly of SiO₂, predominantly of Al₂O₃, predominantly of aluminosilicate, with cerium-stabilized ZrO₂ or chromite. The term “predominantly” is defined to mean a proportion of at least 80 vol.-%, particularly preferably at least 90 vol.-% and more particularly preferably at least 95 vol.-%.

Quartz sand or chromite, which consists predominantly of chromium and iron oxide, or minerals also known as mullite can be used.

The particles can be integrally bonded to a furan resin binder, a phenol resin-based binder or an inorganic binder as a binding agent. A furan resin binder can be a furfuryl alcohol-based binder. Phenol resin-based binders can be hot-curing (e.g. an acid-curing phenol resol binder) or cold-curing. An inorganic binder can be a water-based alkali silicate binder.

Depending on the binder used, the curing can be achieved by thermal treatment at a sufficiently high temperature, irradiation with suitable electromagnetic radiation or by adding a binder-specific curing component to the binder.

The coating with which the surfaces of ribs are covered can be made of polymer resin, such as epoxy resin for example. The coating should be closed and have a layer thickness of at least 50 μm.

The proportion of binder with which the particles are integrally bonded should be in the range of 1 vol. % to 5 vol. % in relation to the amount of integrally bonded particles. Preferably, the proportion is approx. 2 vol.-%.

The ribs of the rib structure should be formed with particles having an average particle size d₅₀ in the range of 63 μm to 1000 μm.

Open pockets should be formed at the openings forming the flow channels to receive impurities contained in a melt in a predefined position and dimension. This can be achieved by additive manufacturing processes which will be discussed in more detail in the following, by carrying out appropriately controlled manufacturing.

In principle, the manufacturing process is carried out in such a way that ribs with particles made of a material that can be used as a molding material in casting technology are formed layer-by-layer by locally defined integral bonding of the particles with a binder. At the beginning of the curing process or after the binder has cured, the surface of the ribs is coated with a polymer resin. The curing can begin with the formation of a rib structure in one layer and then be continued until complete curing has been achieved. A subsequent layer can be formed in a structured manner if complete curing has not yet been achieved. In these cases, preferably a curing component can be applied together with the binder or irradiation with suitable electromagnetic radiation can be used to achieve curing. Alternatively however, a thermal treatment can also be carried out at a temperature sufficient to cure the binder. Thermal treatment can be carried out on a green body that already has the three-dimensional basic rib structure of a filter element.

In powder bed-based additive manufacturing, the loose particles or particles which may already contain part of the binder or be coated with binder, can be applied as a layer to a structural platform and particles of the uppermost layer can be exposed to the binder in a locally defined manner, thereby bonding the particles together in a locally defined manner in the plane of the respective layer. The binder should be applied in a metered and two-dimensionally controlled manner along the surface of a respective layer, that has been formed by loose particles.

After forming a predetermined geometric rib structure for the plane of a respective layer by the integrally bonded connection of particles to binder, the structural platform is then lowered by a layer thickness and a new layer of loose particles is applied, in which particles are again integrally bonded with binder to form a predetermined geometric rib structure in this plane.

The method steps of layer application, locally defined integral bonding of particles with the binder and lowering the structural platform are repeated until the predetermined three-dimensional rib structure of the filter element has been formed.

After this, loose particles which are not integrally bonded are firstly removed and then the coating is applied to the surfaces of the ribs using a polymer resin. The coating can be formed by dipping, flooding or spraying.

As an alternative to powder bed-based manufacturing, an uncoated filter element can be formed by pure printing. In this case, a paste/suspension, which is formed with the particles and the binder and possibly with a curing component, is applied layer-by-layer through at least one nozzle until the three-dimensional rib structure with the ribs and openings are formed as flow channels and then the coating is applied to the surfaces of the ribs with a polymer resin. Depending on the respective binder, curing takes place either after a layer or coating of the paste/suspension has been formed or only after a complete rib structure has been created. The paste/suspension can be applied by metering either in the form of individual drops or in the form of filaments. In this case, the at least one nozzle is positioned accordingly by two-dimensional movement of its outlet opening and the applied mass flow of suspension is controlled in a locally defined manner according to the geometry and the dimensions of the rib structure.

For example, a commercially available 20 ppi ceramic foam filter (50 mm×50 mm×20 mm) can be scanned using micro-computer tomography in order to obtain a true-to-original CAD model of a ceramic foam filter. This CAD model is then additively manufactured in three dimensions using sand and binder. In this case, a quartz sand mixed with activator (p-toluene sulfonic acid) (SiO₂: >99.1 vol.-%; average particle size d₅₀ 0.14 mm) is applied layer-by-layer to a structural platform and then printed with binder which cures with the formation of furan resin (binder content: 2 vol.-%). To increase the mechanical and thermal strength the printed filter geometry in the form of a three-dimensional rib structure is then impregnated with a polymer resin on the surfaces of the ribs.

The filter element obtained in this way, was then tested for its thermal shock behavior and for the dynamic and thermal loads that occur when casting aluminum using a test method to determine the thermal shock resistance of molten aluminum. The filter element withstood the loads and did not break. Furthermore, the thermal decomposition of the filter element could already be recognized as bright spots on the filter element, which means that after use the filter element breaks down to its basic components and it is also possible to recover residual molten material.

In the preliminary test described here, a ceramic foam filter structure was selected as the template for controlling additive manufacturing, as this acts as a worst case for the mechanical and thermal forces that occur due to the low rib thickness of 0.5 mm.

Casting tests with an aluminum melt have shown that, despite the low rib thicknesses, an additively manufactured filter element, which consists essentially of the bonded particles of a molded material, can withstand the expected loads and that melt purification can also be achieved. Furthermore, further tests have shown that a filter element according to the invention thermally decomposes after use and can thus be completely separated from the solidified aluminum and impurities deposited on the filter element during use. The invention can be used to provide filter elements with defined retention and/or flow structures. Examples of applications have shown that even very filigree three-dimensional rib structures can be implemented and that these structures, after impregnation with polymer resin on the rib surfaces, can withstand the loads that occur, at least in the case of aluminum casting.

By way of the invention, flow-optimized filter geometries can be provided by means of additive manufacturing with an advantageous filter element material. It is thus possible to configure and manufacture a filter element with improved fluidic conditions. The flexibility of the design and the reproducible manufacturing process avoid the disadvantages of a ceramic foam filter. When processing the filter element material, loose, pourable particles are wetted or mixed with a binding agent in layers. In this way, sufficient strength can be achieved through the material bonding. After use and a flow through with liquid melt, the filter element can at least partially disintegrate due to thermal decomposition of the binder. The material bond between the particles is at least largely dissolved and the used particles, which are again in loose form, can be introduced into the material cycle of a foundry. No substances to be put in landfill are produced.

The invention offers possibilities for an optimized configuration or layout of the entire filter element geometry, which in particular includes the dimensioning of ribs, openings with the alignment of flow channels formed by openings, through which the liquid melt can flow in such a way that a laminar flow can be achieved after passing through a filter element and the greatest possible retention capacity for impurities. This makes it possible to develop a filter element with defined flow channels and separator pockets and make them available in reality. The reproducible and design-free processing of the filter material is a new method not yet established on the market.

Research has shown that it is not known that such filter element structures are currently being used or developed. The development of filter elements which are produced additively in this way is characterized by a high degree of innovation.

The invention also has ecological and economic advantages as a result of using new filter structures. Compared to ceramic foam filters, the additive production of the flow-optimized filter structures requires significantly less energy, as the sintering process of the ceramic slip is no longer necessary. This makes production much more environmentally friendly and foundries can reduce their CO₂-footprint by using the filter elements according to the invention. As an additively manufactured filter element decomposes due to the thermal effect of the melt after casting and the particulate material can be returned to the material cycle, it is possible to save landfill and transport costs. Furthermore, the additively manufactured filter elements are considerably cheaper to produce than ceramic foam filters, both in large and small-scale production. A further key advantage of the development is that the filter structures can be specifically configured for their respective area of application.

The starting materials to be used are low cost and a relatively small amount of energy is required for the production of filter elements.

1-8. (canceled)

9. A filter element for flow stabilization and/or purifying a melt obtained during casting, which is passed through the filter element, wherein the filter element is in the form of three-dimensional rib structures with openings as flow channels through which liquid melt is passed, and
ribs of the rib structure are formed with particles made from a material, which can be used as molding material in casting technology, and with a binder by which the particles are integrally bonded to one another, and the ribs are provided on their surface with a coating of polymer resin.

10. The filter element according to claim 9, characterized in that the particles are formed predominantly of SiO₂, predominantly of Al₂O₃, predominantly of aluminosilicate, with cerium-stabilized ZrO₂ or chromite and/or
the particles are integrally bonded with a furan resin binder, a phenol resin-based binder or an inorganic binder as a binder and/or the coating is formed by a polymer resin.

11. The filter element according to claim 9, characterized in that a proportion of binder with which the particles are integrally bonded is maintained in the range of 1 vol.-% to 5 vol.-% in relation to the amount of integrally bonded particles.

12. The filter element according to claim 9, characterized in that the ribs are formed with particles having an average particle size of d₅₀ in the range of 63 μm to 1000 μm.

13. The filter element according to claim 9, characterized in that open pockets for receiving impurities contained in a melt in a predefined position and dimension are formed at the openings forming flow channels.

14. A method for producing a filter element according to claim 9, characterized in that rib particles, made from a material which can be used as molding material in casting technology, are formed in layers by the locally defined integral bonding of the particles with a binder, and at the start of curing or after the curing of the binder the surface of the ribs is covered with a coating of polymer resin.

15. The method according to claim 14, characterized in that the loose particles or particles, which already contain binder or are coated with binder, are applied as a layer to a structural platform and particles of the respective uppermost layer are subjected to the binder in a locally defined manner and particles are thereby bonded to one another in a locally defined manner in the plane of the respective layer, and
after forming a predetermined geometric rib structure for the plane of a respective layer by integrally bonding particles with binder the structural platform is lowered by a layer thickness and a new layer of loose particles is applied, in which particles are again materially bonded to binder in order to form a predetermined geometric rib structure in this plane, wherein
the method steps of the layer application, locally defined integral bonding of particles with the binder and lowering the structural platform are repeated until the predetermined three-dimensional rib structure of the filter element has been formed and after this firstly loose particles which are not integrally bonded are removed and
then the coating of a polymer resin is applied to the surfaces of the ribs which cures under normal conditions and/or by thermal treatment and/or irradiation with electromagnetic radiation and/or by the addition of a catalyst.

16. The method according to claim 14, characterized in that a paste formed with the particles and the binder is applied layer-by-layer through at least one nozzle until the three-dimensional rib structure with the ribs and openings are formed as flow channels and then the coating of a polymer resin is applied to the surfaces of the ribs.
